(19) United States
(12) Patent Application Publication
(10) Pub. No.: US 2002/0091742 A1
(43) Pub. Date: Jul. 11, 2002

(54) Method, apparatus, signals and media for providing custom output in response to user input and e-mail system employing same

(75) Inventor: Mark Miller Chesser, Richmond (CA)

Correspondence Address: Alan C. Rose, Oppenheimer Wolff & Donnelly LLP, 2029 Century Park East, 38th Floor, Los Angeles, CA, 90067, US

(73) Assignee: Infowave Software, Inc.

(21) Appl. No.: 09/755,898

(22) Filed: Jan. 5, 2001

(51) Int. Cl. G06F 17/21

(52) U.S. Cl. 707/534; 707/526

(57) ABSTRACT

A method and apparatus for producing custom output in response to user input is disclosed. The method involves producing custom output in response to user input by locating in a programmable device at least one user-specified output character associated with user input in response to receipt of an input code representing the user input, and providing the at least one user-specified output character for use by an application program. The method may involve receiving the input code from a web interface in communication with a communications system such as a wireless communications system. There is also disclosed an e-mail system comprising a web server operable to establish communications with devices using the World Wide Web, and an e-mail server operable to communicate with the web server. At least one of the web server and the e-mail server is programmed to produce at least one user-specified output character for use in a field of an e-mail in response to receipt of an input code from one of the devices.

### BACKGROUND OF THE INVENTION

1. Field of Invention

This invention relates to apparatus, methods, signals and media for producing custom output in response to user input and to applications programs such as e-mail systems employing same. Aspects of the invention may relate to e-mail systems for use by output limited devices.

2. Description of Related Art

Many new portable wireless devices are being equipped with microbrowsers which allow users to access web pages in a handheld device markup language (HDML), wireless markup language (WML), or hypertext markup language (HTML) format, for example, from remote locations. Such microbrowsers are similar to conventional browsers but are optimized for producing displays on small devices. Typically, these microbrowsers provide for text input only and display no, or limited graphics.

Generally, data input capabilities of microbrowsers is facilitated in two forms, namely free text input and static menu choices. Free text input is provided by permitting the user to define the contents of a particular field, such as an e-mail subject field, for example, by using a keypad, such as a telephone keypad on a wireless telephone, to individually enter each character into the field. Once the user has completed entering all desired characters, the complete set of entered characters is sent, using the wireless network, from the portable device to an e-mail server. Using the static menu method, the device displays a choice list to the user, allowing a phrase or desired action to be selected from the list. Desired actions may include e-mail control actions such as such as delete or reply, for example.

Free text input is painstakingly time consuming while use of the choice list involves selecting from choices which are made to be very general so as to be useable by a wide range of people. Often this results in an impractical set of choices, of which none is particularly applicable. What would be desirable therefore is a system that would allow individual users to specify their own unique menu choices, thereby providing a degree of customization to the use of microbrowsers.

### SUMMARY OF THE INVENTION

The present invention addresses the above problems in the prior art by providing methods and apparatus for producing custom output in response to user input. In accordance with one aspect of the invention, the method may involve locating in a programmable device at least one user-specified output character associated with user input, in response to receipt of an input code representing the user input, and providing the at least one user-specified output character for use by an application program.

In one embodiment, the method may involve receiving the input code from a web interface, or more particularly from a communications system such as a wireless communications system. The input code may originate at a wireless telephone, for example.

The method may further involve providing the output character to an application program, and performing an action based on the output character at the application program. Providing the output character may involve providing a linguistic phrase to the application program, and performing an action at the application program in response to the linguistic phrase. The action may include inserting the linguistic phrase into a field of an e-mail.

The method may further involve programming the programmable device by associating at least one output character with a corresponding input code to associate linguistic phrases with corresponding input codes. Programming the programmable device may involve receiving the at least one user-specified character from a user input device.

Programming commands for associating the at least one output character with the input code may be received from a communications network. Programming may involve presenting a programming interface to a user to facilitate receiving the programming commands. This may be achieved by operating a web server to permit users to use personal computers or other web communication appliances to access a web page at which a user can specify and associate output characters or phrases with buttons on a wireless device such that activation of a button causes the associated output character or phase to be provided to an application program. Thus, in effect, the output associated with respective buttons can be customized by a user, and thus a dynamic menu of choices is available to a user. For example, the user may wish to change the mapping of buttons to output on a daily basis. A set or sets of input codes and corresponding output characters may be related to a single user or multiple users.

In accordance with another aspect of the invention, there is provided an apparatus for producing custom output in response to user input. The apparatus comprises a programmable device storing at least one user-specified output character associated with user input and a processor circuit. The processor circuit is operable to locate in the programmable device the at least one user-specified output character in response to receipt of an input code representing the user input and is operable to provide the at least one user-specified output character for use by an application program.

In accordance with another aspect of the invention, there is provided provisions for producing custom output in response to user input. The apparatus includes provisions for storing at least one user-specified output character associated with user input, and provisions for locating at least one user-specified output character associated with user input in response to receipt of an input code representing the user input. The apparatus further includes provisions for providing the at least one user-specified output character for use by an application program.

In accordance with another aspect of the invention, there is provided a computer readable medium. The computer readable medium provides codes for directing a processor circuit to locate in a programmable device at least one user-specified output character associated with user input in response to receipt of an input code representing the user input. The computer readable medium also provides the at least one user-specified output character for use by an application program.

In accordance with another aspect of the invention, there is provided a signal embodied in a carrier wave. The signal includes a first code segment for directing a processor circuit to locate in a programmable device at least one user-specified output character associated with user input in response to receipt of an input code representing the user input. The signal also includes a second code segment for directing a processor circuit to provide the at least one user-specified output character for use by an application program.

In accordance with another aspect of the invention, there is provided system for producing user-defined output characters in response to input codes produced by a web-communicating input device. The system includes a web server operable to establish communications with the web-communicating device using the World Wide Web. The web server is programmed to produce at least one user-specified output character for use in a field of an e-mail produced by an e-mail server in communication with the web server, in response to receipt by the web server of an input code from the web-communicating input device.

In accordance with another aspect of the invention, there is provided an e-mail system comprising a web server operable to establish communications with devices using the World Wide Web, and an e-mail server operable to communicate with the web server. At least one of the web server and the e-mail server is programmed to produce at least one user-specified output character for use in a field of an e-mail in response to receipt of an input code from one of the devices.

The web server and the e-mail server may be implemented on a common computer or they may be implemented on separate computers.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention,

FIG. 1 is a FIG. 1 is a schematic representation of an e-mail system according to one aspect of the invention incorporating an apparatus according to another aspect of the invention;

FIG. 2 is a block diagram of a processor circuit of the apparatus shown in FIG. 1;

FIG. 3 is a flowchart of a programming algorithm run by the processor circuit shown in FIG. 2;

FIG. 4 is a pictorial representation of a web page produced by the processor circuit shown in FIG. 2;

FIG. 5 is a tabular representation of a plurality of device records produced by the algorithm shown in FIG. 3;

FIG. 6 is a flowchart of a hook program run by the processor circuit shown in FIG. 2.

### DETAILED DESCRIPTION

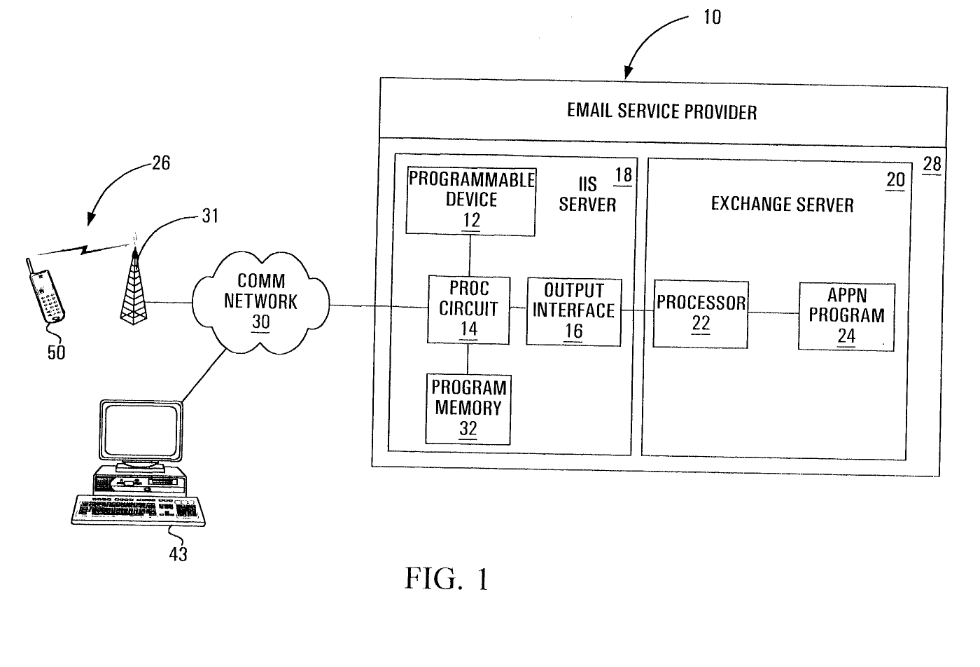

Referring to FIG. 1, an e-mail system in accordance with a first embodiment of the invention is shown generally at 10.

The e-mail system 10 includes an Internet Information Services (IIS) web server 18 that cooperates with an exchange server 20. The exchange server includes a processor 22 running an e-mail application program 24 to provide e-mail services to wireless telephones in a wireless telephone network depicted generally at 26. Together, the IIS web server 18 and exchange server 20 act as an e-mail service provider 28 to subscribing users of the wireless telephone network 26.

The wireless telephone network 26 is in communication with the IIS web server 18 using a packet switched network such as the internet 30, which provides for communications between a base station 31 of the wireless telephone network 26 and the IIS web server 18. The ability of the IIS server 18 to communicate using the internet 30 also permits users to communicate with the IIS server using their own personal computer 43 as will be described below.

The e-mail system 10 may be used with other communications systems other than the wireless telephone network, however, it is particularly well adapted for use with wireless communications systems because wireless telephones typically produce a limited set of codes in response to user actions such as hard or soft key presses. The IIS server 18 shown in this embodiment provides for a user to associate input codes, produced by a wireless device such as a wireless telephone 50, with user-specified output characters stored in a programmable device 12 such that certain user-specified output characters are provided to the application program 24 in response to corresponding user input codes received from the wireless device 50. In this way buttons on the wireless telephone can be used to place user-defined text in fields of e-mail, for example.

To achieve this end, the IIS server 18 includes the programmable device 12 which stores at least one user-specified output character associated with user input. The IIS server 18 further includes a processor circuit 14 operable to locate in the programmable device 12 the at least one user-specified output character, in response to receipt of an input code representing user input and operable to provide the at least one user-specified output character for use by an application program. The user-specified output character may be represented by a code such as an ASCII code, for example.

The IIS server 18 further includes an output interface 16 for communication with the processor 22 of the exchange server 20, and a program memory 32 for storing a program for directing the processor circuit 14 to carry out the functions described herein.

The processor circuit 14 is programmed by blocks of codes which act as instructions for directing the processor circuit to carry out certain functions to cause the output interface 16 to provide a character or string of characters to the application program 24 running on the exchange server 20. In an alternative embodiment, codes may be provided to cause the exchange server 20 to be implemented on the same processor circuit 14. The blocks of codes which direct the processor circuit 14 to carry out the functionality described herein may be provided to the processor circuit by a CD-ROM or other computer readable medium, for example, or they may be provided in code segments which are part of a signal embodied in a carrier wave, which is received by the apparatus 10, for example. Generally, the blocks of codes are stored in the program memory 32.

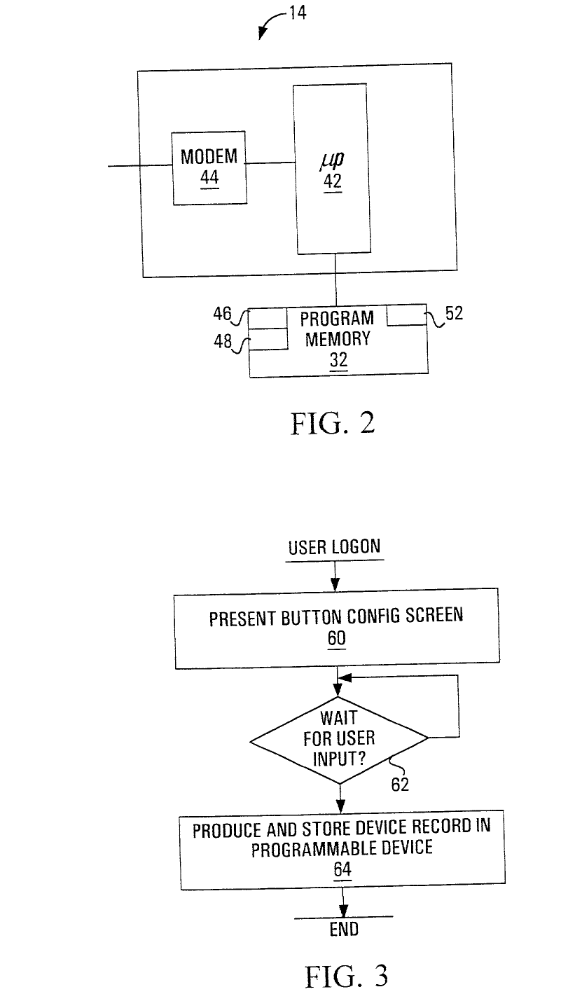

Referring to FIG. 2 in this embodiment, the processor circuit 14 includes a microprocessor 42 and a receiving interface including a modem 44 and codes 46 stored in the program memory 32 for directing the processor circuit to act as a web interface to permit input codes to be received from the internet 30 shown in FIG. 1. These codes which direct the processor circuit 14 to receive input codes from the internet 30 also configure the processor circuit to cooperate with the wireless communications system 26, through the internet, to receive input codes from the wireless communications system and more particularly to receive input codes from a wireless device 50 of a subscriber of the service who is communicating on the wireless communications system.

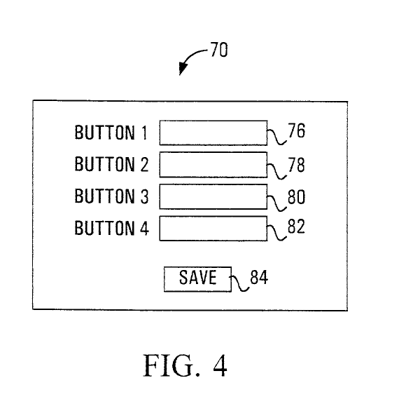

In addition, the receiving interface includes codes 48 that direct the processor circuit 14 to program the programmable device 12 shown in FIG. 1, to associate at least one output character and/or linguistic phase with a corresponding input code. Referring to FIGS. 1 and 3, to do this, the codes 48 include a first block 60 which directs the processor circuit 14 to present a user entry button configuration screen, in HTML format, for example, to a user who has used a browser on his or her own personal computer 43 shown in FIG. 1, to navigate to a logon uniform resource locator (URL) hosted by the IIS server 18. After completing a typical user logon sequence, the user is presented with a user entry button configuration screen, an example of which is shown in FIG. 4.

Referring to FIG. 4, the user entry button configuration screen may be as depicted generally at 70 including button character-association fields 76, 78, 80 and 82. The user may then navigate to the button character-association fields 76-82 and enter a character, character string, or linguistic phrase which he or she desires to be produced when the corresponding button is activated on his or her wireless device. For example, in the first button character-association field 76, the user may enter the linguistic phrase “I'll be on vacation from December 20-January 3 and during this period you can reach me at (604) 666-3655”. Other phrases can be entered into the remaining button character-association fields. When the user has entered the desired linguistic phrases or characters into the button character-association fields 76-82, the user may activate a save button 84.

Referring back to FIG. 3, while the user enters characters and until the save button 84 shown in FIG. 4 is actuated, the processor circuit 14 buffers the characters entered by the user and waits for more user input as indicated by block 62. When the save button 84 is actuated, the processor circuit 14 is directed to block 64 of FIG. 3, which causes it to associate with the user a device record and to store the device record in the programmable device 12 shown in FIG. 1. The device record serves to associate a set of input codes and corresponding output characters with a user. Optionally, multiple users can be associated with a single set of input codes and corresponding output characters. In effect, the web page shown in FIG. 4 acts as a programming interface to facilitate entry and receipt of programming commands from a subscribing user to facilitate association of input codes produced by buttons on the wireless device with user-specified output characters and/or linguistic phrases.

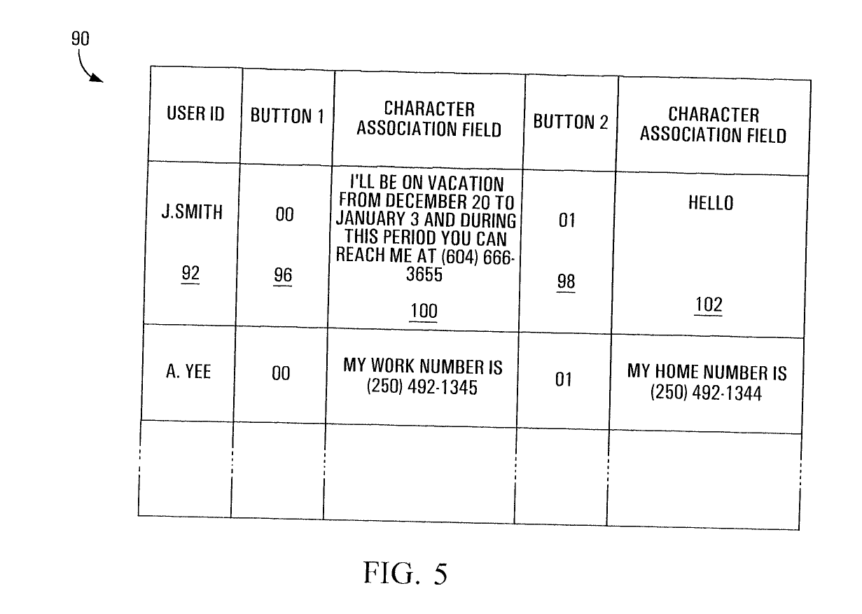

A device record, according to this embodiment is shown generally at 90 in FIG. 5 and includes a user ID field 92, button fields for each button on the user's wireless device, only two of which are shown at 96 and 98, and character-association fields 100 and 102 associated with button fields 96 and 98 respectively. It will be appreciated that the record structure shown here may be implemented in a variety of ways, including a linked list, for example.

Referring back to FIGS. 1 and 2, the processor circuit 14 is further programmed to provide a unique URL to each subscribing user, to permit each subscribing user to associate his or her own unique, custom phrases with user-entry buttons on his or her own wireless device 50 as described above, and to permit each user to have a corresponding device record 90 in the programmable device 12. Thus, a data structure of device records is produced and maintained by the processor circuit 14. In other words, the processor circuit 14 relates sets of input codes and corresponding output characters to corresponding users. For ease of representation this data structure is shown as a table at 90 in FIG. 5, but may take on any other suitable form of structure. It will be appreciated that lists of codes produced by user entry buttons on popular wireless devices 50 may be stored in memory and retrieved as required to produce unique web pages corresponding to a subscribing user's wireless device. Thus, when a user subscribes to the system he or she identifies the wireless device 50 with which the system is to cooperate. This identifies the corresponding button configuration and pre-defined input codes produced by the wireless device 50.

Referring back to FIG. 2, the program memory 32 further includes intercept codes 52 for directing the processor circuit 14 to interact with the modem 44 to establish communications between the exchange server 20 shown in FIG. 1 and the wireless communications system 26 shown in that Figure. The intercept codes 52, however, include a hook to intercept user entry button press codes produced by a device of a subscribing user and to retrieve the corresponding user-specified output character, characters or linguistic phrase from the programmable device 12 shown in FIG. 1 and to pass it/them to the application program, which in this embodiment is the e-mail application program 24.

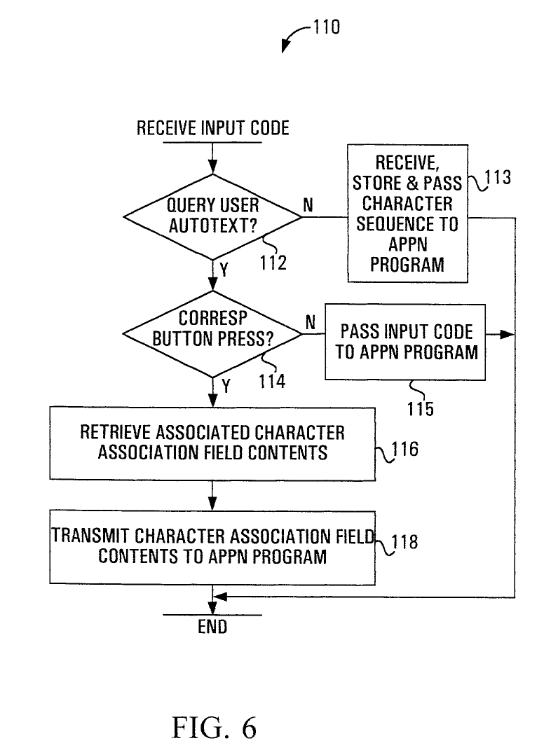

In this embodiment, the hook which performs this function is shown generally at 110 in FIG. 6. The hook is invoked or otherwise rendered operational when the user logs on to the IIS server 18 shown in FIG. 1. The logon procedure causes the username to be identified which provides an index into the table shown at 90 in FIG. 5 to access the character sequences or linguistic phrases associated with respective buttons on the wireless device 50. It is assumed that any time any button is activated on the wireless device 50, the wireless device produces an input code including a data portion. The data portion represents a function activated by the user at the wireless device 50. The function could include activation of any of the user entry buttons described above, and/or could include activation of any other buttons such as dial pad buttons, for example.

Referring to FIG. 6, on receipt of an input code a first block 112 directs the processor circuit 14 to send a message back to the wireless device querying the user as to whether or not the button press is to be interpreted as an autotext entry. If not, then block 113 directs the processor circuit 14 to receive single characters, in sequence from the user device and to pass a received sequence of such characters to the application program 24 shown in FIG. 1. The processor circuit 14 shown in FIG. 2 then awaits the next input code from the wireless device 50.

Referring back to FIG. 6, if at the first block 112 the user indicates that the button press is to be used to produce the pre-stored output character sequence associated with that button, a second block 114 of the hook directs the processor circuit 14 to extract the data portion from the input code and to determine whether there is a matching button press code associated with the user ID. If a matching button press code cannot be found, the hook is ended, in which case block 115 causes the input code to be passed directly to the application program 24. If a matching button press code is found, block 116 directs the processor circuit 14 to retrieve from the programmable device 12 the associated character-association field contents for the matching button, and block 118 directs the processor circuit 14 to transmit the character-association field contents to the application program 24. This is done by transmitting to the application program 24 a substitute input code comprised of the contents of the character-association field, as the data portion of the input code. The hook is then ended and the processor circuit 14 awaits receipt of another input code.

Using the example shown, when the user who associated the linguistic phrase indicated above presses on his or her wireless device 50 the corresponding user-entry button he/she specified in the web page shown at 70 in FIG. 4, the linguistic phrase “I'll be on vacation from December 20-January 3 and during this period you can reach me at (604) 666-3655” is provided to the application program 24. If the application program 24 was prompting for text input to be placed in the body of an e-mail, for example, the body of such e-mail would now contain this phrase.

Thus, when a subscribing user presses a user entry button on his or her wireless device 50, a character, characters and/or linguistic phrase previously associated with such user entry button is provided to the application program 24 as a substitute for the code normally produced by the wireless device. As each user can specify his or her own character, characters, and linguistic phrases to be associated with user entry buttons on his or her wireless device 50, users are not confined to using general phrases non-specific to their needs.

The IIS server 18 essentially acts as an apparatus for producing user-defined output characters in response to input codes produced by a web-communicating input device. The IIS server 18 is operable to establish communications with the web-communicating input device using the World Wide Web and is programmed to produce at least one user-specified output character for use in a field of an e-mail produced by an e-mail server in communication with the IIS server, in response to receipt of an input code, from the web-communicating input device.

Together the IIS server 18 and the exchange server 20 act as an e-mail system comprising a web server operable to establish communications with devices using the World Wide Web and an e-mail server operable to communicate with the web server. At least one of the web server and the e-mail server is programmed to produce at least one user-specified output character for use in a field of an e-mail in response to receipt of an input code from one of the devices.

While specific embodiments of the invention have been described and illustrated, such embodiments should be considered illustrative of the invention only and not as limiting the invention as construed in accordance with the accompanying claims.

What is claimed is:

1. A method of producing custom output in response to user input, the method comprising:
a) locating in a programmable device at least one user-specified output character associated with user input, in response to receipt of an input code representing said user input; and
b) providing said at least one user-specified output character for use by an application program.

2. The method of claim 1 further comprising receiving said input code.

3. The method of claim 2 further comprising receiving said input code from a web interface.

4. The method of claim 3 wherein receiving said input code from a web interface comprises receiving said input code from a communications system.

5. The method of claim 4 wherein receiving said input code from a communications system comprises receiving said input code from a wireless communications system.

6. The method of claim 5 wherein receiving said input code from a wireless communications system comprises receiving said input code from a wireless telephone.

7. The method of claim 1 further comprising providing said output character to an application program.

8. The method of claim 7 further comprising performing an action based on said output character, at said application program.

9. The method of claim 8 further comprising providing a linguistic phrase to said application program in response to receipt of a corresponding input code.

10. The method of claim 9 further comprising performing an action at said application program, in response to said linguistic phrase.

11. The method of claim 10 wherein performing an action comprises inserting said linguistic phrase into a field of an e-mail.

12. The method of claim 1 further comprising programming said programmable device by associating at least one output character with a corresponding input code.

13. The method of claim 12 wherein programming comprises associating linguistic phrases with corresponding input codes.

14. The method of claim 12 wherein programming comprises receiving said at least one user-specified character from a user input device.

15. The method of claim 14 wherein receiving comprises receiving from a communications network programming commands for associating said at least one output character with said input code.

16. The method of claim 12 further comprising presenting a programming interface to a user, to facilitate receiving said programming commands.

17. The method of claim 12 further comprising relating a set of input codes and corresponding output characters to a user.

18. The method of claim 17 wherein relating comprises relating sets of input codes and corresponding output characters to corresponding users.

19. The method of claim 17 wherein producing comprises locating a set of input codes and corresponding output characters, corresponding to a user determined from said input code.

20. An apparatus for producing custom output in response to user input, the apparatus comprising:
a) a programmable device storing at least one user-specified output character associated with user input;
b) a processor circuit operable to locate in said programmable device said at least one user-specified output character, in response to receipt of an input code representing said user input; and operable to provide said at least one user-specified output character for use by an application program.

21. The apparatus of claim 20 further comprising a receiving interface operable to receive said input code.

22. The apparatus of claim 21 wherein said receiving interface further comprises a web interface for receiving said input code.

23. The apparatus of claim 22 wherein said web interface is configured to cooperate with a communications system to receive said input code.

24. The apparatus of claim 22 wherein said web interface is configured to cooperate with a wireless communications system to receive said input code.

25. The apparatus of claim 22 wherein said web interface is configured to receive said input code from a wireless telephone.

26. The apparatus of claim 20 wherein said processor circuit is operable to communicate with the application program.

27. The apparatus of claim 26 wherein said processor circuit is operable to provide a linguistic phrase to the application program in response to receipt of a corresponding input code.

28. The apparatus of claim 27 wherein said processor circuit is operable to provide said linguistic phrase to the application program for use in a field of an e-mail.

29. The apparatus of claim 20 wherein said processor circuit is operable to program said programmable device to associate at least one output character with a corresponding input code.

30. The apparatus of claim 29 wherein said processor circuit is operable to associate linguistic phrases with corresponding input codes.

31. The apparatus of claim 29 further comprising a receiving interface operable to receive said at least one output character from a user input device.

32. The apparatus of claim 31 wherein said receiving interface is operable to receive programming commands from a communications system, to facilitate associating said at least one output character with said input code.

33. The apparatus of claim 31 wherein said receiving interface is operable to present a programming interface to a user, to facilitate receiving said programming commands.

34. The apparatus of claim 29 wherein said processor circuit is operable to relate a set of input codes and corresponding output characters to a user.

35. The apparatus of claim 29 wherein said processor circuit is operable to relate sets of input codes and corresponding output characters to corresponding users.

36. The apparatus of claim 29 wherein said processor circuit is programmed to locate a set of input codes and corresponding output characters, corresponding to a user determined from said input code.

37. An apparatus for producing custom output in response to user input, the apparatus comprising:
a) means for storing at least one user-specified output character associated with user input;
b) means for locating in said means for storing at least one user-specified output character associated with user input, in response to receipt of an input code representing said user input; and
c) means for providing said at least one user-specified output character for use by an application program.

38. A computer readable medium for providing codes for directing a processor circuit to:
a) locate in a programmable device at least one user-specified output character associated with user input, in response to receipt of an input code representing said user input; and
b) provide said at least one user-specified output character for use by an application program.

39. A signal embodied in a carrier wave, said signal comprising:
a) a first code segment for directing a processor circuit to locate in a programmable device at least one user-specified output character associated with user input, in response to receipt of an input code representing said user input; and
b) a second code segment for directing a processor circuit to provide said at least one user-specified output character for use by an application program.

40. An apparatus for producing user-defined output characters in response to input codes produced by a web-communicating input device, the system comprising a web server operable to establish communications with said web-communicating input device using the World Wide Web and programmed to produce at least one user-specified output character for use in a field of an e-mail produced by an e-mail server in communication with said web server, in response to receipt by said web server of an input code, from said web-communicating input device.

41. An e-mail system comprising:
a) a web server operable to establish communications with devices using the World Wide Web;
b) an e-mail server operable to communicate with said web server;
c) at least one of said web server and said e-mail server being programmed to produce at least one user-specified output character for use in a field of an e-mail in response to receipt of an input code from one of said devices.

42. The e-mail system of claim 41 wherein said web server and said e-mail server are implemented on a common computer.

43. The e-mail system of claim 41 wherein said web server and said e-mail server are implemented on separate computers.
